(19) United States
(12) Patent Application Publication
(10) Pub. No.: US 2025/0150596 A1
(43) Pub. Date: May 8, 2025

(54) VIDEO PROCESSING METHOD AND APPARATUS, AND USER EQUIPMENT

(71) Applicant: JINGDONG TECHNOLOGY INFORMATION TECHNOLOGY CO., LTD., Beijing (CN)

(72) Inventor: Jianguang WANG, Beijing (CN)

(21) Appl. No.: 18/930,830

(22) Filed: Oct. 29, 2024

(30) Foreign Application Priority Data
Nov. 8, 2023 (CN) 202311480513.2

(51) Int. Cl. H04N 19/146; H04N 19/142

(52) U.S. Cl. CPC H04N 19/146; H04N 19/142

(57) ABSTRACT

The present disclosure provides a video processing method and apparatus, and a user equipment, and relates to the field of computer technology. The video processing method includes: determining a scene change type of a first video frame sequence of a previous acquisition; determining a frame rate of a current acquisition according to the scene change type of the first video frame sequence and a frame rate of the previous acquisition; controlling an acquisition module to acquire a second video frame sequence according to the frame rate of the current acquisition; encoding the second video frame sequence to obtain an encoding result; and transmitting the encoding result to a target device.

### CROSS-REFERENCE TO RELATED APPLICATION

The present application is based on and claims the priority to the Chinese patent application No. 202311480513.2 filed on Nov. 8, 2023, the disclosure of which is incorporated by reference herein in its entirety.

### TECHNICAL FIELD

The present disclosure relates to the field of computer technology, and in particular, to a video processing method and apparatus, and a user equipment.

### BACKGROUND

During a video conference, there is often a need for screen sharing. The screen sharing typically involves video acquisition, encoding, transmission, decoding, and display processes.

In the related art, a user equipment usually performs video acquisition using a fixed acquisition frame rate, and then encodes and transmits the acquired video. After receiving the encoded video, a target device decodes and displays the encoded video.

### SUMMARY

The present disclosure provides a video processing method and apparatus, and a user equipment.

According to a first aspect of the present disclosure, there is provided a video processing method, comprising: determining a scene change type of a first video frame sequence of a previous acquisition; determining a frame rate of a current acquisition according to the scene change type of the first video frame sequence and a frame rate of the previous acquisition; controlling an acquisition module to acquire a second video frame sequence according to the frame rate of the current acquisition; encoding the second video frame sequence to obtain an encoding result; and transmitting the encoding result to a target device.

In some embodiments, the determining a scene change type of a first video frame sequence of a previous acquisition comprises: determining a scene change feature between two adjacent video frames in the first video frame sequence; determining a distribution of the scene change feature in value intervals corresponding to a plurality of scene change types; and determining the scene change type of the first video frame sequence according to the distribution of the scene change feature in the value intervals corresponding to the plurality of scene change types.

In some embodiments, the determining a scene change feature between two adjacent video frames in the first video frame sequence comprises: obtaining a complexity of each video frame in the first video frame sequence; and determining the scene change feature between the two adjacent video frames according to the complexities of the two adjacent video frames in the first video frame sequence.

In some embodiments, the determining the scene change feature between the two adjacent video frames according to the complexities of the two adjacent video frames in the first video frame sequence comprises: taking a ratio of the complexity of a latter of the two adjacent video frames to the complexity of a former of the two adjacent video frames as the scene change feature between the two adjacent video frames.

In some embodiments, the complexity of each video frame is a sum of absolute difference of the each video frame.

In some embodiments, the plurality of scene change types are N scene change types, N being an integer greater than 1, and the determining the scene change type of the first video frame sequence according to the distribution of the scene change feature in the value intervals corresponding to the plurality of scene change types comprises: under a condition that a ratio of the number of scene change features located in a value interval corresponding to an i-th scene change type to a total number of frames of the first video frame sequence is greater than a number ratio threshold, determining that the first video frame sequence is of the i-th scene change type, where i is an integer greater than or equal to 1 and less than N.

In some embodiments, the number ratio threshold is greater than or equal to 0.5 and less than 1.

In some embodiments, the scene change type of the first video frame sequence is a first scene change type, a second scene change type or a third scene change type, and the determining a frame rate of a current acquisition according to the scene change type of the first video frame sequence and a frame rate of the previous acquisition comprises: under a condition that the first video frame sequence is of the first scene change type, increasing the frame rate of the previous acquisition to obtain the frame rate of the current acquisition; under a condition that the first video frame sequence is of the second scene change type, decreasing the frame rate of the previous acquisition to obtain the frame rate of the current acquisition; and under a condition that the first video frame sequence is of the third scene change type, taking the frame rate of the previous acquisition as the frame rate of the current acquisition.

In some embodiments, the controlling an acquisition module to acquire a second video frame sequence according to the frame rate of the current acquisition is performed under a condition that the frame rate of the current acquisition is less than or equal to an acquisition frame rate threshold.

In some embodiments, the video processing method further comprises under a condition that the frame rate of the current acquisition is greater than the acquisition frame rate threshold, controlling the acquisition module to acquire the second video frame sequence according to the frame rate of the previous acquisition.

In some embodiments, the video processing method is applied to a screen sharing scene in a video conference.

According to a second aspect of the present disclosure, there is provided a video processing apparatus, comprising: a determination module configured to determine a scene change type of a first video frame sequence of a previous acquisition, and determine a frame rate of a current acquisition according to the scene change type of the first video frame sequence and a frame rate of the previous acquisition; an acquisition control module configured to control an acquisition module to acquire a second video frame sequence according to the frame rate of the current acquisition; an encoding module configured to encode the second video frame sequence to obtain an encoding result; and a transmission module configured to transmit the encoding result to a target device.

According to a third aspect of the present disclosure, there is provided a video processing apparatus, comprising: a memory; and a processor coupled to the memory, the processor being configured to, based on instructions stored in the memory, perform the video processing method as described above.

According to a fourth aspect of the present disclosure, there is provided a user equipment, comprising: the video processing apparatus as described above; an acquisition module configured to acquire the second video frame sequence.

According to a fifth aspect of the present disclosure, there is provided a non-transitory computer-readable storage medium having thereon stored computer program instructions which, when executed by a processor, implement the video processing method as described above.

Other features of the present disclosure and advantages thereof will become apparent by the following detailed description of exemplary embodiments thereof, which proceeds with reference to the accompanying drawings.

### BRIEF DESCRIPTION OF THE DRAWINGS

The accompanying drawings, which constitute part of this specification, illustrate embodiments of the present disclosure and together with the description, serve to explain the principles of the present disclosure.

The present disclosure may be more clearly understood according to the following detailed description by referring to the accompanying drawings, in which:

FIG. 1 is a schematic flow diagram of a video processing method according to some embodiments of the present disclosure;

FIG. 2 is a schematic flow diagram of determining a scene change type of a first video frame sequence according to some embodiments of the present disclosure;

FIG. 3 is a schematic diagram of image complexities measured in different scenes;

FIG. 4 is a schematic flow diagram of determining a frame rate of a current acquisition according to some embodiments of the present disclosure;

FIG. 5 is a schematic flow diagram of a video processing method according to other embodiments of the present disclosure;

FIG. 6 is a schematic structural diagram of a video processing apparatus according to some embodiments of the present disclosure;

FIG. 7 is a schematic structural diagram of a video processing apparatus according to other embodiments of the present disclosure;

FIG. 8 is a schematic structural diagram of a user equipment according to some embodiments of the present disclosure;

FIG. 9 is a schematic structural diagram of a computer system according to some embodiments of the present disclosure.

### DETAILED DESCRIPTION

Various exemplary embodiments of the present disclosure will now be described in detail with reference to the accompanying drawings. It should be noted that: relative arrangements, numerical expressions and numerical values of components and steps set forth in these embodiments do not limit the scope of the present disclosure unless specifically stated otherwise.

Meanwhile, it should be understood that for ease of description, sizes of various parts shown in the drawings are not drawn according to an actual scale.

The following description of at least one exemplary embodiment is merely illustrative in nature and is in no way intended to limit this disclosure and its application or uses.

Techniques, methods, and devices known to one of ordinary skill in the related art may not be discussed in detail but should be considered as part of the granted specification where appropriate.

In all examples shown and discussed herein, any specific value should be construed as exemplary only and not as limiting. Thus, other examples of the exemplary embodiments may have different values.

It should be noted that: similar reference numbers and letters refer to similar items in the following figures, and thus, once an item is defined in one figure, it need not be further discussed in subsequent figures.

To make the objectives, technical solutions and advantages of the present disclosure more apparent, the present disclosure will be described in further detail below in conjunction with specific embodiments and with reference to the accompanying drawings.

In the related art, when there is a great change in a scene of a video to be acquired, since a user equipment adopts a fixed acquisition frame rate for video acquisition, the acquisition frame rate cannot be adapted to the scene change of the video, and then a problem of poor viewing experience for a video in a target device or waste of energy consumption in the user equipment may occur.

In view of this, the present disclosure provides a video processing method and apparatus, and a user equipment, capable of dynamically determining an acquisition frame rate of a video according to a scene change of the video, and then realizing dynamic coding of the video, thereby helping to improve video viewing experience in a target device, reduce energy consumption of the user equipment, and alleviate the problem of waste of energy consumption.

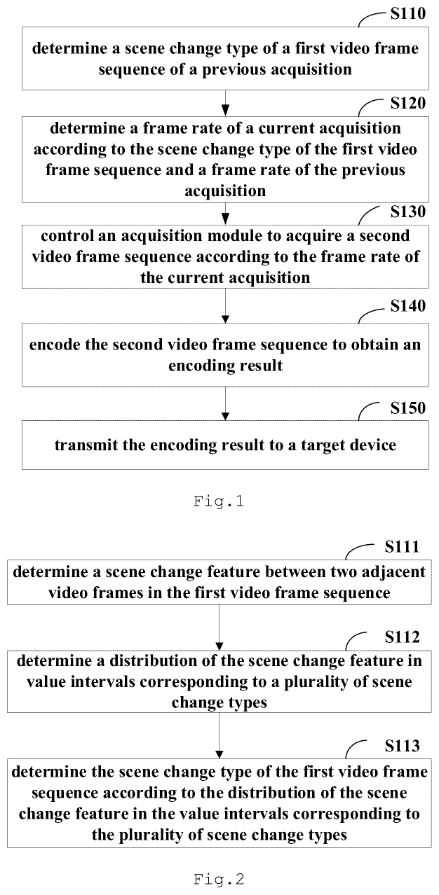

FIG. 1 is a schematic flow diagram of a video processing method according to some embodiments of the present disclosure. As shown in FIG. 1, the video processing method comprises steps S110 to S150.

Step S110 comprises determining a scene change type of a first video frame sequence of a previous acquisition.

In some embodiments, the video processing method is performed by a video processing apparatus. In some examples, the video processing apparatus is a user equipment (such as a cell phone, personal computer, and tablet), or some components (such as a processor) of the user equipment.

In some embodiments, the video processing method is applied to a screen sharing scene in a video conference. In this scene, the video processing method is performed by a user equipment that triggers screen sharing. In addition, the video processing method can also be applied to other scenes related to video sharing.

The video processing method comprises multiple video processing processes, each including video acquisition, encoding and transmission. For a second and subsequent video processing processes, steps S110 to S150 are performed.

In some embodiments, for a first video processing process, video acquisition is performed according to a preset acquisition frame rate.

In some embodiments, in the step S110, encoding feedback information of the first video frame sequence of the previous acquisition is obtained, to determine the scene change type of the first video frame sequence according to the encoding feedback information. For example, the encoding feedback information of the first video frame sequence of the previous acquisition is obtained from a feedback resource pool.

In some examples, in the screen sharing scene in the video conference, the first video frame sequence is a screen image sequence of a previous acquisition made by an acquisition module (such as a camera).

In some examples, the encoding feedback information of the first video frame sequence is a scene feature of each video frame in the first video frame sequence. For example, the scene feature of the video frame is a complexity of the video frame, or motion estimation information of the video frame. In some examples, the complexity of the video frame is characterized by a sum of absolute difference (SATD).

In some embodiments, in the step S110, the scene change type of the first video frame sequence is determined according to the flow diagram shown in FIG. 2.

Step S120 comprises determining a frame rate of a current acquisition according to the scene change type of the first video frame sequence and a frame rate of the previous acquisition.

In some embodiments, there are various scene change types. Different scene change types correspond to different manners of determining the frame rate of the current acquisition. After the scene change type of the first video frame sequence is determined through the step S110, the frame rate of the current acquisition is determined according to a determination manner matched with the scene change type and the frame rate of the previous acquisition. For example, the frame rate of the current acquisition is determined according to the flow diagram shown in FIG. 4.

Step S130 comprises controlling an acquisition module to acquire a second video frame sequence according to the frame rate of the current acquisition.

In some embodiments, in the step S130, the frame rate of the current acquisition is taken as a total number of frames of the second video frame sequence, to control the acquisition module to acquire the second video frame sequence.

In some embodiments, in the step S130, it is determined whether the frame rate of the current acquisition is less than or equal to an acquisition frame rate threshold; and under a condition that the frame rate of the current acquisition is less than or equal to the acquisition frame rate threshold, the acquisition module is controlled to acquire the second video frame sequence according to the frame rate of the current acquisition.

In some embodiments, the video processing method further comprises: under a condition that the frame rate of the current acquisition is greater than the acquisition frame rate threshold, controlling the acquisition module to acquire the second video frame sequence according to the frame rate of the previous acquisition. In some examples, the acquisition frame rate threshold is related to a video acquisition capability of a device. For example, the acquisition frame rate threshold increases with an increase of the video acquisition capability.

In the embodiment of the present disclosure, by determining that the frame rate of the current acquisition is less than or equal to the acquisition frame rate threshold and then acquiring the second video frame sequence according to the frame rate of the current acquisition, it can alleviate an abnormality problem that may be caused by the frame rate of the current acquisition exceeding the video acquisition capability of the device, helping to further improve video viewing experience of a target user.

Step S140 comprises encoding the second video frame sequence to obtain an encoding result.

In some embodiments, in the step S140, the second video frame sequence is subjected to prediction, transformation, quantization, entropy coding and other stages, to obtain the encoding result.

In some embodiments, the video processing method further comprises obtaining encoding feedback information of the second video frame sequence, and storing the encoding feedback information. For example, the encoding feedback information of the second video frame sequence is stored to a feedback resource pool.

In some examples, the encoding feedback information is a complexity of each video frame. For example, the complexity is characterized by a sum of absolute difference (SATD) of each video frame.

Step S150 comprises transmitting the encoding result to a target device.

In some embodiments, after receiving the encoding result, the target device decodes it, and displays a decoded video.

In the embodiment of the present disclosure, the video processing processes such as dynamic and adaptive video frame acquisition and encoding are achieved through the above steps. In this way, it is possible to make the determined acquisition frame rate match the scene change of the video frame, alleviate problems of video lag caused by a too small acquisition frame rate and waste of energy consumption of the video processing apparatus caused by a too large acquisition frame rate, thereby helping to reduce the energy consumption of the video processing apparatus while improving video viewing experience of a target user.

FIG. 2 is a schematic flow diagram of determining a scene change type of a first video frame sequence according to some embodiments of the present disclosure. As shown in FIG. 2, the process of determining the scene change type of the first video frame sequence comprises steps S111 to S113.

Step S111 comprises determining a scene change feature between two adjacent video frames in the first video frame sequence.

In some embodiments, in the step S111, a complexity of each video frame in the first video frame sequence is obtained; and the scene change feature between the two adjacent video frames is determined according to the complexities of the two adjacent video frames in the first video frame sequence.

For example, assuming that the first frame sequence includes K video frames, in the step S111, a scene change feature between a 2nd video frame and a 1st video frame, a scene change feature between a 3rd video frame and the 2nd video frame, . . . , and a scene change feature between a K-th video frame and a (K−1)-th video frame are determined.

In some examples, a ratio of the complexity of the latter of the two adjacent video frames to the complexity of the former of the two adjacent video frames is taken as the scene change feature between the two adjacent video frames.

For example, when a complexity of a video frame is characterized by a sum of absolute difference (SATD), the scene change feature between the two adjacent video frames is determined according to the following formula:

$$frame Cpx Rate [ i ] = frame Cpx [ i ] / frame Cpx [ i - 1 ]$$

where frameCpxRate[i] represents a scene change feature between an i-th video frame and an (i−1)-th video frame, frameCpx[i] represents a sum of absolute difference of the i-th video frame, and frameCpx[i−1] represents a sum of absolute difference of the (i−1)-th video frame.

In the embodiment of the present disclosure, by calculating the scene change feature using the complexity of the video frame, it is possible to better reflect the scene change between two adjacent frames, thereby helping to improve the accuracy of type determination of the whole video frame sequence. Further, the scene change feature between the two adjacent video frames is characterized by the complexity ratio, so that a value range of the scene change feature is controllable, helping to better reflect the scene change between the two adjacent frames, thereby improving the accuracy of type determination of the whole video frame sequence.

In other examples, a difference between the complexity of the latter of the two adjacent video frames and the complexity of the former of the two adjacent video frames is calculated, and a ratio of the difference to the complexity of the former video frame is taken as the scene change feature between the two adjacent video frames.

Step S112 comprises determining a distribution of the scene change feature in value intervals corresponding to a plurality of scene change types.

In some embodiments, value intervals of scene change features corresponding to the plurality of scene change types are preset. In the step S112, the number of scene change features falling in each value interval, in the scene change features between the two adjacent video frames in the first video frame sequence, is counted.

For example, assuming that the first video frame sequence has K video frames in total and value intervals corresponding to 3 scene change types are preset, the number of scene change features falling in each value interval, in K−1 scene change features obtained through the step S111, is counted.

Step S113 comprises determining the scene change type of the first video frame sequence according to the distribution of the scene change feature in the value intervals corresponding to the plurality of scene change types.

In some embodiments, in the step S113, the scene change type of the first video frame sequence is determined as follows: under a condition that a ratio of the number of scene change features located in a value interval corresponding to an i-th scene change type to a total number of frames of the first video frame sequence is greater than a number ratio threshold, determining that the first video frame sequence is of the i-th scene change type, wherein i is an integer greater than or equal to 1 and less than N. N is a total number of the value intervals corresponding to the scene change types, and N is an integer greater than 1.

In some examples, the value intervals corresponding to the scene change types include: a value interval corresponding to a first scene change type, a value interval corresponding to a second scene change type, and a value interval corresponding to a third scene change type. The value interval corresponding to the first scene change type represents that the scene becomes complex, the value interval corresponding to the second scene change type represents that the scene becomes simple, and the value interval corresponding to the third scene change type represents that a complexity of the scene is basically unchanged. In these examples, under a condition that a ratio of the number of scene change features located in the value interval corresponding to the first scene change type to the total number of frames of the first video frame sequence is greater than a first number ratio threshold, it is determined that the first video frame sequence is of the first scene change type; under a condition that a ratio of the number of scene change features located in the value interval corresponding to the second scene change type to the total number of frames of the first video frame sequence is greater than a second number ratio threshold, it is determined that the first video frame sequence is of the second scene change type; and under a condition that a ratio of the number of scene change features located in the value interval corresponding to the third scene change type to the total number of frames of the first video frame sequence is greater than a third number ratio threshold, it is determined that the first video frame sequence is of the third scene change type.

In some examples, the scene change feature is characterized by the ratio of the complexity of the latter of the two adjacent video frames to the complexity of the former of the two adjacent video frames. In some embodiments of these examples, the value interval corresponding to the first scene change type is that the scene change feature is greater than 1.2, the value interval corresponding to the second scene change type is that the scene change feature is less than 0.8, and the value interval corresponding to the third scene change type is that the scene change feature is greater than 0.95 and less than 1.05. In addition, in specific implementations, a size of the value interval corresponding to each scene change type can be flexibly set according to actual requirements.

In some examples, the number ratio threshold corresponding to each scene change type is greater than or equal to 0.5 and less than 1.

In some examples, the number ratio thresholds corresponding to different scene change types are the same. For example, the number ratio thresholds corresponding to the first scene change type, the second scene change type, and the third scene change type are all 0.5.

In some examples, the number ratio thresholds corresponding to different scene change types are different. For example, the number ratio threshold corresponding to the first scene change type (i.e., the first number ratio threshold) is 0.5, the number ratio threshold corresponding to the second scene change type (i.e., the second number ratio threshold) is 2/3, and the number ratio threshold corresponding to the third scene change type (i.e., the third number ratio threshold) is 0.5.

In other embodiments, in the step S113, the scene change type of the first video frame sequence is determined as follows: under a condition that a ratio of the number of scene change features located in a value interval corresponding to an i-th scene change type to a total number of the scene change feature corresponding to the first video frame sequence is greater than a number ratio threshold, determining that the first video frame sequence is of the i-th scene change type, wherein i is an integer greater than or equal to 1 and less than N. N is the total number of the value intervals corresponding to the scene change types, and N is an integer greater than 1.

In the embodiment of the present disclosure, by determining the scene change type of the whole video frame sequence using the counting result of the scene change feature between the adjacent video frames, it is possible to improve the accuracy of type determination of the scene change, thereby helping to more accurately determine the acquisition frame rate, improve video viewing experience of the target user, and reduce energy consumption of the video processing apparatus. Further, in the embodiment of the present disclosure, by determining the scene change type of the video frame sequence according to the comparison result of the number ratio and the number ratio threshold, it is possible to improve the accuracy, flexibility and applicability of the determined scene change type.

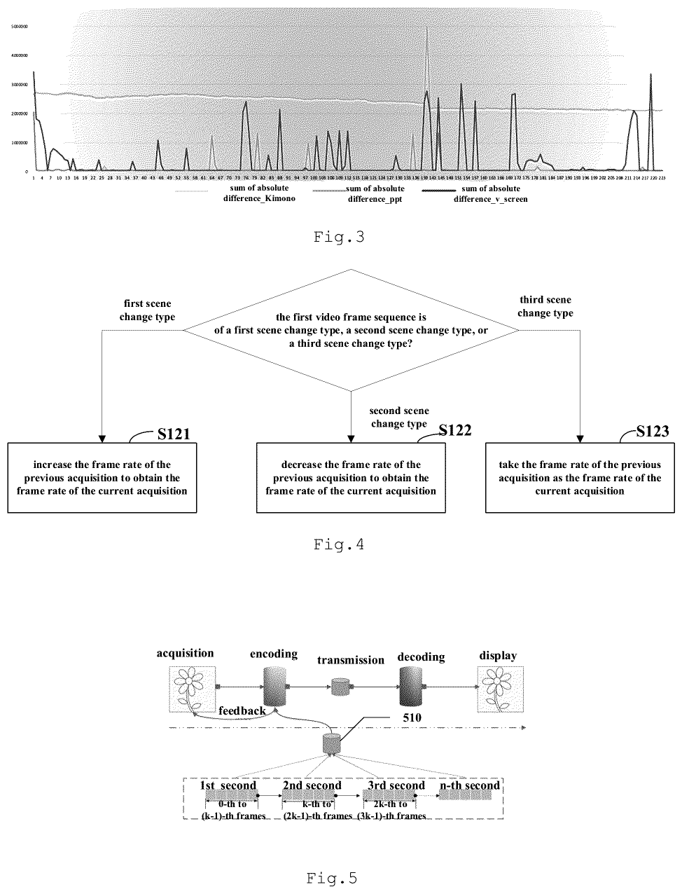

FIG. 3 is a schematic diagram of image complexities measured in different scenes. As shown in FIG. 3, an abscissa indicates a serial number of a video frame, and an ordinate indicates a calculated sum of absolute difference (SATD) of each frame. 3 curves in the figure represent SATD curves of a video frame sequence in three scenes. A kimono curve represents that there are complex objects in a scene and less changes in a complexity of the scene as a whole; a v_screen curve represents that there are video playback in acquired content and more scene switching and changes; and a ppt curve represents an SATD curve of the video frame sequence in a ppt playback scene. As can be seen from FIG. 3, the SATD can well characterize a complexity of a scene.

FIG. 4 is a schematic flow diagram of determining a frame rate of a current acquisition according to some embodiments of the present disclosure. As shown in FIG. 4, the process of determining the frame rate of the current acquisition comprises: under a condition that the first video frame sequence is of the first scene change type, performing step S121, that is, increasing the frame rate of the previous acquisition to obtain the frame rate of the current acquisition.

In some embodiments, the scene change type of the first video frame sequence is of the first scene change type, the second scene change type, or the third scene change type. The first scene change type indicates that the scene becomes complex, the second scene change type indicates that the scene becomes simple, and the third scene change type indicates that the complexity of the scene is basically unchanged.

In some embodiments, under a condition that the first video frame sequence is of the first scene change type, the frame rate of the previous acquisition is increased according to a set coefficient to obtain the frame rate of the current acquisition. For example, twice the frame rate of the previous acquisition is taken as the frame rate of the current acquisition.

In some embodiments, under a condition that the first video frame sequence is of the first scene change type, an increase coefficient is determined according to the ratio of the number of the scene change features located in the value interval corresponding to the first scene change type to the total number of the frames of the first video frame sequence; and the frame rate of the previous acquisition is increased according to the increase coefficient to obtain the frame rate of the current acquisition. For example, the increase coefficient is in positive correlation with the ratio.

As shown in FIG. 4, the process of determining the frame rate of the current acquisition further comprises: under a condition that the first video frame sequence is of the second scene change type, performing step S122, that is, decreasing the frame rate of the previous acquisition to obtain the frame rate of the current acquisition.

In some embodiments, under a condition that the first video frame sequence is of the second scene change type, the frame rate of the previous acquisition is decreased according to a set coefficient to obtain the frame rate of the current acquisition. For example, 0.5 times the frame rate of the previous acquisition is taken as the frame rate of the current acquisition.

In some embodiments, under a condition that the first video frame sequence is of the second scene change type, a decrease coefficient is determined according to the ratio of the number of the scene change features located in the value interval corresponding to the second scene change type to the total number of frames of the first video frame sequence; and the frame rate of the previous acquisition is decreased according to the decrease coefficient to obtain the current acquisition frame rate. For example, the less the ratio, the less the decrease coefficient.

As shown in FIG. 4, the process of determining the frame rate of the current acquisition further comprises: under a condition that the first video frame sequence is of the third scene change type, performing step S123, that is, taking the frame rate of the previous acquisition as the frame rate of the current acquisition.

In the embodiment of the present disclosure, by dynamically setting the frame rate of the current acquisition according to different scene change types, the acquisition frame rate is adapted to the scene change, helping to improve video viewing experience of the target user and reduce energy consumption of the video processing apparatus.

FIG. 5 is a schematic flow diagram of a video processing method according to other embodiments of the present disclosure. As shown in FIG. 5, the video processing method comprises: video acquisition, video encoding, video transmission, video decoding, and video display.

In some embodiments, the video acquisition, video encoding, video transmission are performed by a user equipment, or a video processing apparatus disposed on the user equipment. The video decoding and the video display are performed by a target device or a video processing apparatus disposed on the target device. For example, in a screen sharing scene in a video conference, a user equipment is a device initiating screen sharing, and a target device is another user equipment other than this user equipment in user equipment participating in the video conference.

In some embodiments, the video processing apparatus of the user equipment obtains encoding feedback information of a first video frame sequence of a previous acquisition from a resource pool 510, and determines a frame rate of a current acquisition according to the encoding feedback information and a frame rate of the previous acquisition.

For example, the resource pool 510 has therein stored encoding feedback information of a plurality of video frame sequences, for example, encoding feedback information of a video frame sequence of a first acquisition (such as encoding feedback information of k video frames numbered from 0 to k−1 of a first-second acquisition), encoding feedback information of a video frame sequence of a second acquisition (such as encoding feedback information of k video frames numbered from k to 2k−1 of a second-second acquisition), encoding feedback information of a video frame sequence of a third acquisition (such as encoding feedback information of k video frames numbered from 2k to 3k−1 of a third-second acquisition), and encoding feedback information of a video frame sequence of an n-th acquisition.

In some examples, the encoding feedback information of the first video frame sequence comprises a complexity of each video frame in the first video frame sequence. The complexity of each video frame is characterized by a sum of absolute difference.

In some examples, after the complexity of each video frame in the first video frame sequence is obtained from the resource pool 510, the frame rate of the current acquisition is determined as follows: step a1, determining a scene change feature between two adjacent video frames according to the complexity of the latter of the two adjacent video frames and the complexity of the former of the two adjacent video frames; step a2, determining a scene change type of the first video frame sequence according to a distribution of the scene change feature between the two adjacent video frames in value intervals corresponding to a plurality of scene change types; and step a3, determining the frame rate of the current acquisition according to the scene change type of the first video frame sequence and the frame rate of the previous acquisition.

In some embodiments, in the step a1, a ratio of the complexity of the latter of the two adjacent video frames to the complexity of the former of the two adjacent video frames is taken as the scene change feature between the two adjacent video frames.

In some embodiments, in the step a2, the number of scene change features falling in the value interval corresponding to each scene change type is counted; a ratio of the number of scene change features falling in the value interval corresponding to each scene change type to a total number of frames of the first video frame sequence is calculated; and the scene change type of the first video frame sequence is determined according to a comparison result of the ratio and a number ratio threshold.

For example, value intervals corresponding to first to third scene change types are preset. The value interval corresponding to the first scene change type meets the scene change feature being greater than 1.2, indicating that the scene becomes complex; the value interval corresponding to the second scene change type meets the scene change feature being less than 0.8, indicating that the scene becomes simple; and the value interval corresponding to the third scene change type meets the scene change feature being greater than 0.95 and less than 1.05, indicating that a complexity of the scene is basically unchanged.

For example, when a ratio of the number of scene change features falling in the value interval corresponding to the first scene change type to the total number of frames of the first video frame sequence is greater than 0.5, it is determined that the first video frame sequence is of the first scene change type; when a ratio of the number of scene change features falling in the value interval corresponding to the second scene change type to the total number of frames of the first video frame sequence is greater than 2/3, it is determined that the first video frame sequence is of the second scene change type; and when a ratio of the number of scene change features falling in the value interval corresponding to the third scene change type to the total number of frames of the first video frame sequence is greater than 0.5, it is determined that the first video frame sequence is of the third scene change type.

In some embodiments, in the step a3, when the first video frame sequence is of the first scene change type, the frame rate of the previous acquisition is increased to obtain the frame rate of the current acquisition; when the first video frame sequence is of the second scene change type, the frame rate of the previous acquisition is decreased to obtain the frame rate of the current acquisition; and when the first video frame sequence is of the third scene change type, the frame rate of the previous acquisition is taken as the frame rate of the current acquisition.

After determining the frame rate of the current acquisition, the video processing apparatus of the user equipment performs the following steps: controlling an acquisition module (such as a camera) to acquire a second video frame sequence; encoding the second video frame sequence to obtain an encoding result; and transmitting the encoding result to a target device.

After receiving the encoding result, the target device decodes the encoding result to obtain a decoded video; and displays the decoded video.

In the embodiment of the present disclosure, by using the above method, the acquisition frame rate is adapted to the scene change, helping to improve video viewing experience of the target user and reduce energy consumption of the video processing apparatus.

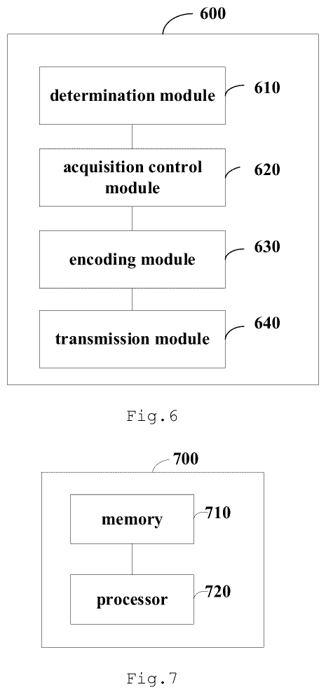

FIG. 6 is a schematic structural diagram of a video processing apparatus according to some embodiments of the present disclosure. As shown in FIG. 6, the video processing apparatus 600 comprises a determination module 610, an acquisition control module 620, an encoding module 630, and a transmission module 640.

In some embodiments, the video processing apparatus 600 is a user equipment (such as a cell phone, a personal computer, and a tablet) or some components (such as a processor) of the user equipment.

For example, in a screen sharing scene in a video conference, the video processing apparatus 600 is a user equipment that triggers screen sharing, or a processor of the user equipment.

The determination module 610 is configured to determine a scene change type of a first video frame sequence of a previous acquisition, and determine a frame rate of a current acquisition according to the scene change type of the first video frame sequence and a frame rate of the previous acquisition.

In some embodiments, the determination module 610 determines the scene change type of the first video frame sequence of the previous acquisition as follows: determining a scene change feature between two adjacent video frames in the first video frame sequence; determining a distribution of the scene change feature in value intervals corresponding to a plurality of scene change types; and determining the scene change type of the first video frame sequence according to the distribution of the scene change feature in the value intervals corresponding to the plurality of scene change types.

In some examples, the determination module 610 determines the scene change feature between the two adjacent video frames in the first video frame sequence as follows: obtaining a complexity of each video frame in the first video frame sequence; and determining the scene change feature between the two adjacent video frames according to the complexities of the two adjacent video frames in the first video frame sequence.

For example, the determination module 610 takes a ratio of the complexity of the latter of the two adjacent video frames to the complexity of the former of the two adjacent video frames as the scene change feature between the two adjacent video frames.

For example, the complexity of each video frame is characterized by a sum of absolute difference of each video frame.

In some examples, the plurality of scene change types are N scene change types, N being an integer greater than 1. The determination module 610 is configured to: under a condition that a ratio of the number of scene change features located in a value interval corresponding to an i-th scene change type to a total number of frames of the first video frame sequence is greater than a number ratio threshold, determine that the first video frame sequence is of the i-th scene change type, wherein i is an integer greater than or equal to 1 and less than N.

For example, the scene change types comprise a first scene change type, a second scene change type, and a third scene change type. A value interval corresponding to the first scene change type is a first value interval, a value interval corresponding to the second scene change type is a second value interval, and a value interval corresponding to the third scene change type is a third value interval. In this example, the determination module 610 is configured to: in a case where a ratio of the number of scene change features falling in the first value interval to the total number of frames of the first video frame sequence is greater than 0.5, determine that the first video frame sequence is of the first scene change type; in a case where a ratio of the number of scene change features falling in the second value interval to the total number of frames of the first video frame sequence is greater than 2/3, determine that the first video frame sequence is of the second scene change type; and in a case where a ratio of the number of scene change features falling in the third value interval to the total number of frames of the first video frame sequence is greater than 0.5, determine that the first video frame sequence is of the third scene change type.

The acquisition control module 620 is configured to control an acquisition module to acquire a second video frame sequence according to the frame rate of the current acquisition.

In some embodiments, the acquisition control module 620 is configured to: take the frame rate of the current acquisition as a total number of frames of the second video frame sequence to control the acquisition module to acquire the second video frame sequence. For example, the acquisition module is a camera.

In some embodiments, the acquisition control module 620 is configured to: determine whether the frame rate of the current acquisition is less than or equal to an acquisition frame rate threshold; and in a case where the current acquisition frame rate is less than or equal to the acquisition frame rate threshold, control the acquisition module to acquire the second video frame sequence according to the frame rate of the current acquisition. In addition, the acquisition control module 620 is further configured to: in a case where the frame rate of the current acquisition is greater than the acquisition frame rate threshold, control the acquisition module to acquire the second video frame sequence according to the frame rate of the previous acquisition. In some examples, the acquisition frame rate threshold is related to a video acquisition capability of the device. For example, the acquisition frame rate threshold is increased with the increase of the video acquisition capability.

In some embodiments of the present disclosure, by determining that the frame rate of the current acquisition is less than or equal to the acquisition frame rate threshold and then acquiring the second video frame sequence according to the frame rate of the current acquisition, it is possible to alleviate an abnormality that may be caused by the current acquisition frame rate exceeding the video acquisition capability of the device, helping to further improve video viewing experience of the target user.

The encoding module 630 is configured to encode the second video frame sequence to obtain an encoding result.

The transmission module 640 is configured to transmit the encoding result to a target device.

In the embodiment of the present disclosure, by using the above video processing apparatus, it is possible to dynamically determine an acquisition frame rate of a video according to a scene change of the video, thereby realizing dynamic encoding of the video. In this way, it helps to improve video viewing experience of the target device, reduce energy consumption of the user equipment, and alleviate the problem of waste of energy consumption.

FIG. 7 is a schematic structural diagram of a video processing apparatus according to other embodiments of the present disclosure.

As shown in FIG. 7, the video processing apparatus 700 comprises a memory 710; and a processor 720 coupled to the memory 710. The memory 710 is configured to store instructions for performing the embodiments corresponding to the video processing method. The processor configured to, based on the instructions stored in the memory 710, perform the video processing method in any of the embodiments of the present disclosure.

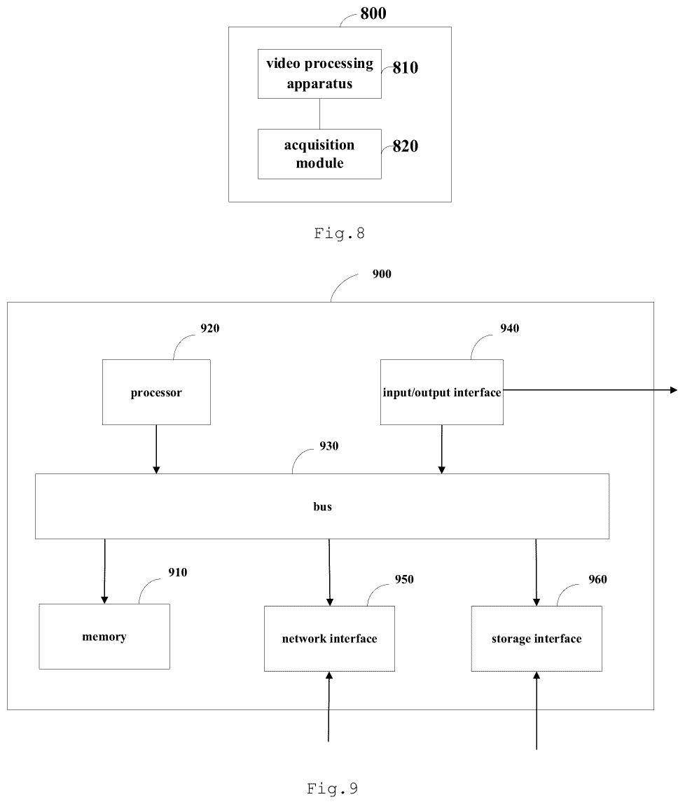

FIG. 8 is a schematic structural diagram of a user equipment according to some embodiments of the present disclosure. As shown in FIG. 8, the user equipment 800 comprises a video processing apparatus 810 and an acquisition module 820.

The video processing apparatus 810 is configured to perform the video processing method as described above.

The video processing method comprises multiple video processing processes, each video processing process including video acquisition, encoding and transmission. A second video processing process and each subsequent video processing process comprise: determining a scene change type of a first video frame sequence of a previous acquisition; determining a frame rate of a current acquisition according to the scene change type of the first video frame sequence and a frame rate of the previous acquisition; controlling an acquisition module to acquire a second video frame sequence according to the frame rate of the current acquisition; encoding the second video frame sequence to obtain an encoding result; and transmitting the encoding result to a target device. In some embodiments, a first video processing process comprises performing video acquisition according to a preset acquisition frame rate.

The acquisition module 820 is configured to acquire a video frame sequence under control of the video processing apparatus 810. For example, in an (i−1)-th video processing process, the acquisition module 820 acquires the first video frame sequence; and in an i-th video processing process, the acquisition module 820 acquires the second video frame sequence, where i is an integer greater than 1.

In the embodiment of the present disclosure, by using the user equipment, it can dynamically determine an acquisition frame rate of a video according to a scene change of the video, thereby realizing the dynamic encoding of the video. In this way, it helps to improve video viewing experience of the target device, reduce energy consumption of the user equipment, and alleviate the problem of waste of energy consumption.

FIG. 9 is a schematic structural diagram of a computer system according to some embodiments of the present disclosure.

As shown in FIG. 9, the computer system 900 may be embodied in a form of a general-purpose computing device. The computer system 900 comprises a memory 910, a processor 920, and a bus 930 that connects different system components.

The memory 910 may include, for example, a system memory, non-volatile storage medium, and the like. The system memory has therein stored, for example, an operating system, application, boot loader, other programs, and the like. The system memory may include a volatile storage medium, such as a random access memory (RAM) and/or cache memory. The non-volatile storage medium has therein stored, for example, instructions for performing at least one embodiment corresponding to the video processing method. The non-volatile storage medium includes, but is not limited to, a magnetic disk memory, optical memory, flash memory, and the like.

The processor 920 may be implemented using discrete hardware components, such as a general-purpose processor, digital signal processor (DSP), application specific integrated circuit (ASIC), field programmable gate array (FPGA) or other programmable logic devices, discrete gate or transistor. Accordingly, each of the modules such as the determination module, the acquisition control module, the encoding module and the transmission module may be implemented by a central processing unit (CPU) executing the instructions in the memory that perform the corresponding steps, or by a dedicated circuit performing the corresponding steps.

The bus 930 may use any of a variety of bus architectures. For example, the bus architectures include, but are not limited to, an industry standard architecture (ISA) bus, micro channel architecture (MCA) bus, and peripheral component interconnect (PCI) bus.

The interfaces 940, 950, 960 and memory 910 of the computer system 900 may be connected with the processor 920 via the bus 930. The input/output interface 940 may provide a connection interface for an input/output device such as a display, a mouse, and a keyboard. The network interface 950 provides a connection interface for various networking devices. The storage interface 960 provides a connection interface for external storage devices such as a floppy disk, USB flash disk, and SD card.

Various aspects of the present disclosure have been described herein with reference to the flow diagrams and/or block diagrams of the method, apparatus and computer program product according to the embodiments of the present disclosure. It should be understood that each block of the flow diagrams and/or block diagrams, and a combination of blocks in the flow diagrams and/or block diagrams, can be implemented by computer-readable program instructions.

These computer-readable program instructions may be provided to a processor of a general-purpose computer, special-purpose computer, or other programmable apparatuses to produce a machine, such that by executing the instructions by the processor, means for realizing the functions specified in one or more blocks in the flow diagrams and/or block diagrams are produced.

These computer-readable program instructions may also be stored in a computer-readable memory, and these instructions cause a computer to work in a specific manner, thereby producing an article of manufacture, including instructions for realizing the functions specified in one or more blocks in the flow diagrams and/or block diagrams.

The present disclosure may take a form of an entire hardware embodiment, an entire software embodiment, or an embodiment combining software and hardware aspects.

By means of the video processing method and apparatus, and the user equipment in the above embodiments, it is possible to dynamically determine an acquisition frame rate of a video according to a scene change of the video, thereby realizing dynamic coding of the video, helping to improve video viewing experience of a target device, reduce energy consumption of the user equipment, and alleviate the problem of waste of energy consumption.

So far, the video processing method and apparatus, and the user equipment according to the present disclosure have been described in detail. Some details well known in the art have not been described in order to avoid obscuring the concepts of the present disclosure. Those skilled in the art can fully appreciate how to implement the technical solutions disclosed herein according to the foregoing description.

What is claimed is:

1. A video processing method, comprising:
determining a scene change type of a first video frame sequence of a previous acquisition;
determining a frame rate of a current acquisition according to the scene change type of the first video frame sequence and a frame rate of the previous acquisition;
controlling an acquisition module to acquire a second video frame sequence according to the frame rate of the current acquisition;
encoding the second video frame sequence to obtain an encoding result; and
transmitting the encoding result to a target device.

2. The video processing method according to claim 1, wherein the determining a scene change type of a first video frame sequence of a previous acquisition comprises:
determining a scene change feature between two adjacent video frames in the first video frame sequence;
determining a distribution of the scene change feature in value intervals corresponding to a plurality of scene change types; and
determining the scene change type of the first video frame sequence according to the distribution of the scene change feature in the value intervals corresponding to the plurality of scene change types.

3. The video processing method according to claim 2, wherein the determining a scene change feature between two adjacent video frames in the first video frame sequence comprises:
obtaining a complexity of each video frame in the first video frame sequence; and
determining the scene change feature between the two adjacent video frames according to the complexities of the two adjacent video frames in the first video frame sequence.

4. The video processing method according to claim 3, wherein the determining the scene change feature between the two adjacent video frames according to the complexities of the two adjacent video frames in the first video frame sequence comprises:
taking a ratio of the complexity of a latter of the two adjacent video frames to the complexity of a former of the two adjacent video frames as the scene change feature between the two adjacent video frames.

5. The video processing method according to claim 3, wherein the complexity of each video frame is a sum of absolute difference of each video frame.

6. The video processing method according to claim 3, wherein the plurality of scene change types are N scene change types, N being an integer greater than 1, and the determining the scene change type of the first video frame sequence according to the distribution of the scene change feature in the value intervals corresponding to the plurality of scene change types comprises:
under a condition that a ratio of the number of scene change features located in a value interval corresponding to an i-th scene change type to a total number of frames of the first video frame sequence is greater than a number ratio threshold, determining that the first video frame sequence is of the i-th scene change type, where i is an integer greater than or equal to 1 and less than N.

7. The video processing method according to claim 6, wherein the number ratio threshold is greater than or equal to 0.5 and less than 1.

8. The video processing method according to claim 1, wherein the scene change type of the first video frame sequence is a first scene change type, a second scene change type, or a third scene change type, and the determining a frame rate of a current acquisition according to the scene change type of the first video frame sequence and a frame rate of the previous acquisition comprises:
under a condition that the first video frame sequence is of the first scene change type, increasing the frame rate of the previous acquisition to obtain the frame rate of the current acquisition;
under a condition that the first video frame sequence is of the second scene change type, decreasing the frame rate of the previous acquisition to obtain the frame rate of the current acquisition; and
under a condition that the first video frame sequence is of the third scene change type, taking the frame rate of the previous acquisition as the frame rate of the current acquisition.

9. The video processing method according to claim 1, wherein the controlling an acquisition module to acquire a second video frame sequence according to the frame rate of the current acquisition is performed under a condition that the frame rate of the current acquisition is less than or equal to an acquisition frame rate threshold.

10. The video processing method according to claim 9, further comprising:
under a condition that the frame rate of the current acquisition is greater than the acquisition frame rate threshold, controlling the acquisition module to acquire the second video frame sequence according to the frame rate of the previous acquisition.

11. The video processing method according to claim 1, wherein the video processing method is applied to a screen sharing scene in a video conference.

12. A video processing apparatus, comprising:
a memory; and
a processor coupled to the memory, the processor being configured to, based on instructions stored in the memory, perform a video processing method comprising:
determining a scene change type of a first video frame sequence of a previous acquisition;
determining a frame rate of a current acquisition according to the scene change type of the first video frame sequence and a frame rate of the previous acquisition;
controlling an acquisition module to acquire a second video frame sequence according to the frame rate of the current acquisition;
encoding the second video frame sequence to obtain an encoding result; and
transmitting the encoding result to a target device.

13. The video processing apparatus according to claim 12, whereinto determine the scene change type of the first video frame sequence of the previous acquisition, the processor is configured to:
determine a scene change feature between two adjacent video frames in the first video frame sequence;
count a distribution of the scene change feature in value intervals corresponding to a plurality of scene change types; and
determine the scene change type of the first video frame sequence according to the distribution of the scene change feature in the value intervals corresponding to the plurality of scene change types.

14. The video processing apparatus according to claim 13, whereinto determine the scene change feature between the two adjacent video frames in the first video frame sequence, the processor is configured to:
obtain a complexity of each video frame in the first video frame sequence; and
determine the scene change feature between the two adjacent video frames according to the complexities of the two adjacent video frames in the first video frame sequence.

15. The video processing apparatus according to claim 14, whereinto determine the scene change feature between the two adjacent video frames, the processor is configured to:
take a ratio of the complexity of a latter of the two adjacent video frames to the complexity of a former of the two adjacent video frames as the scene change feature between the two adjacent video frames.

16. A user equipment, comprising:
the video processing apparatus according to claim 12; and
an acquisition module configured to acquire the second video frame sequence.

17. A non-transitory computer-readable storage medium having thereon stored computer program instructions which, when executed by a processor, implement a video processing method comprising:
determining a scene change type of a first video frame sequence of a previous acquisition;
determining a frame rate of a current acquisition according to the scene change type of the first video frame sequence and a frame rate of the previous acquisition;
controlling an acquisition module to acquire a second video frame sequence according to the frame rate of the current acquisition;
encoding the second video frame sequence to obtain an encoding result; and
transmitting the encoding result to a target device.

18. The non-transitory computer-readable storage medium according to claim 17, wherein to determine the scene change type of the first video frame sequence of the previous acquisition, the instructions, when executed by the processor, cause the processor to:
determine a scene change feature between two adjacent video frames in the first video frame sequence;
count a distribution of the scene change feature in value intervals corresponding to a plurality of scene change types; and
determine the scene change type of the first video frame sequence according to the distribution of the scene change feature in the value intervals corresponding to the plurality of scene change types.

19. The non-transitory computer-readable storage medium according to claim 18, wherein to determine the scene change feature between the two adjacent video frames in the first video frame sequence, the instructions, when executed by the processor, cause the processor to:
obtain a complexity of each video frame in the first video frame sequence; and
determine the scene change feature between the two adjacent video frames according to the complexities of the two adjacent video frames in the first video frame sequence.

20. The non-transitory computer-readable storage medium according to claim 19, wherein to determine the scene change feature between the two adjacent video frames, the instructions, when executed by the processor, cause the processor to:
take a ratio of the complexity of a latter of the two adjacent video frames to the complexity of a former of the two adjacent video frames as the scene change feature between the two adjacent video frames.
